(19) United States
(12) Patent Application Publication
(10) Pub. No.: US 2009/0288322 A1
(43) Pub. Date: Nov. 26, 2009

(54) Method of displaying and advertisement in a vehicle

(76) Inventor: Francesca G. Farmer-Luczak, Algonquin, IL (US)

Correspondence Address: Benjamin I. Edlavitch, PO BOX 220661, Chicago, IL, 60622-0661, US

(21) Appl. No.: 12/387,349

(22) Filed: May 1, 2009

Related U.S. Application Data
(60) Provisional application No. 61/128,751, filed on May 23, 2008.

(51) Int. Cl. G09F 21/04; G09F 21/06; G09F 21/18

(52) U.S. Cl. 40/593

(57) ABSTRACT

A method of displaying an advertisement on a seat or meal tray of vehicle, including seats or meal trays of an aircraft, watercraft, automobile, or train. Though others have displayed an advertisement on a meal tray of a vehicle, this application describes specific locations of placement on a seat or meal tray, which are both novel and not obvious. Moreover, this application expresses a novel manner of placing and connecting an advertisement to a meal tray or seat of a vehicle.

### BACKGROUND

Advertisers are always looking for new locations to place their advertisements, especially locations on vehicles that transport many people. Traditionally, advertisers place their advertisements on an interior or exterior wall of a vehicle or on an exterior or interior surface of a vehicle window. Recently, some advertisers have placed their advertisements on interior objects of a vehicle, such as seats or meal trays.

### SUMMARY

Described herein, is a method of displaying an advertisement on a seat or meal tray of vehicle, including seats or meal trays of an aircraft, watercraft, automobile, or train. Though others have displayed an advertisement on a meal tray of a vehicle, this application describes specific locations of placement on a seat or meal tray that are both novel and not obvious. Moreover, this application expresses a novel manner of placing and connecting an advertisement to a meal tray or seat of a vehicle.

In preferred implementations of the method, the displayed advertisement is a print advertisement. However, the method may include displaying an advertisement electronically via a monitor or other form of electronic display.

In preferred implementations of the method, either a top or a bottom surface of a meal tray or a part of a back surface of a seat displays an advertisement. In either case, it is preferred that the surfaces display the advertisement at specific locations of the surfaces, which this application describes in detail in the Detailed Description section.

In preferred implementations of the method, an advertisement is printed on a laminated sticker, where the laminate material and adhesive of the sticker is heat and water-resistant. The laminate is also graffiti resistant, and the sticker adheres to the surface of a meal tray for at least sixty days.

### BRIEF DESCRIPTION OF THE DRAWINGS

Below is a description of example implementations of a method of displaying an advertisement on a seat or meal tray of a vehicle, in conjunction with appended drawings, wherein like reference numerals refer to like elements in figures, and wherein:

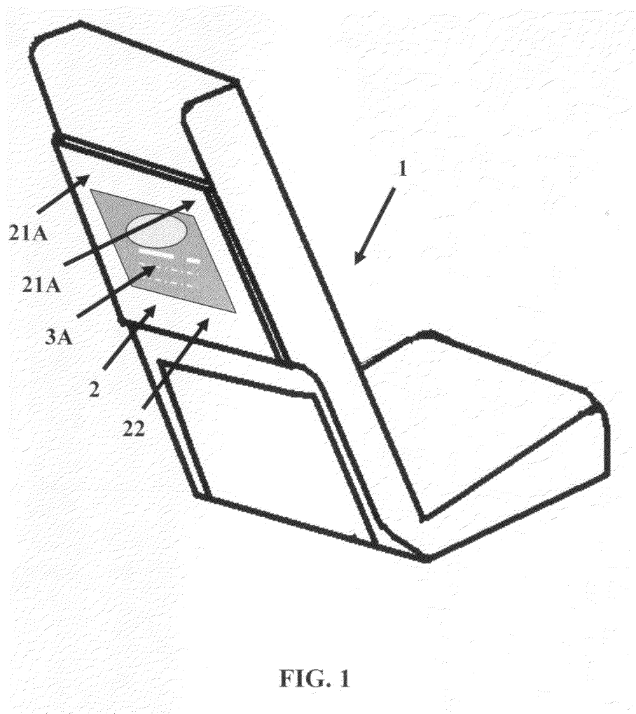

figure one (labeled “FIG. 1” in the drawings) illustrates one preferred position of the advertisement;

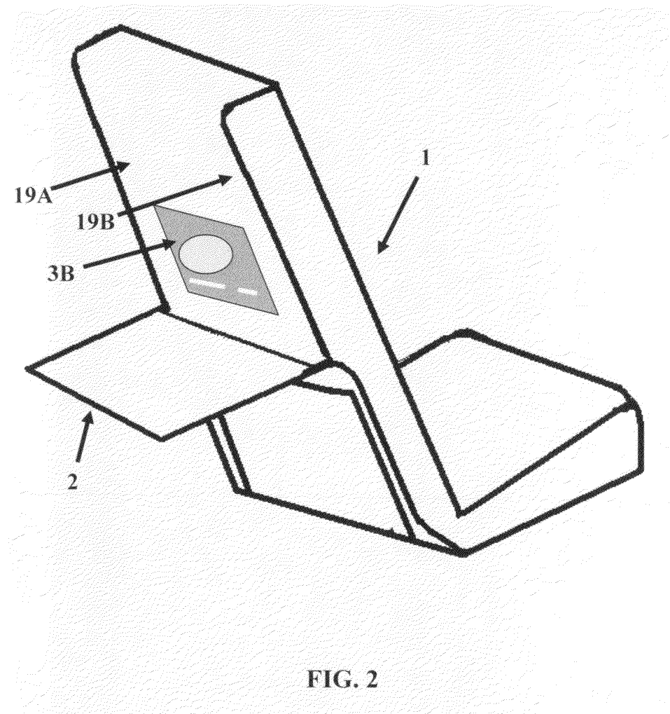

figure two (labeled “FIG. 2” in the drawings) illustrates one preferred position of the advertisement;

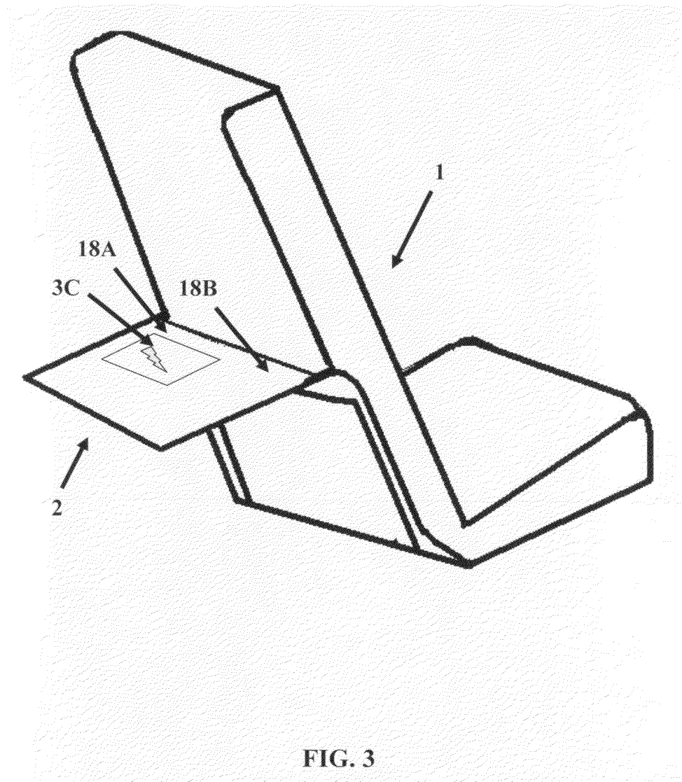

figure three (labeled “FIG. 3” in the drawings) illustrates one preferred position of the advertisement;

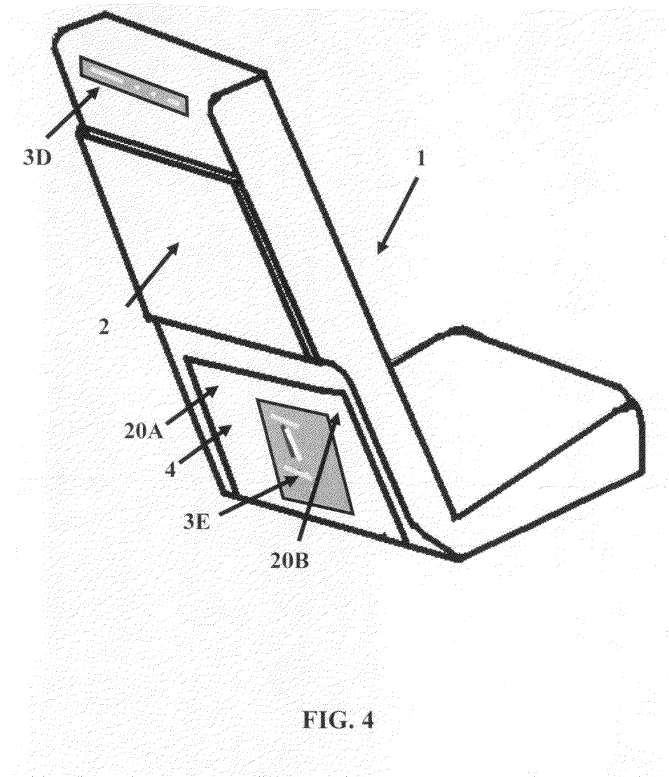

figure four (labeled “FIG. 4” in the drawings) illustrates one preferred position of the advertisement; and

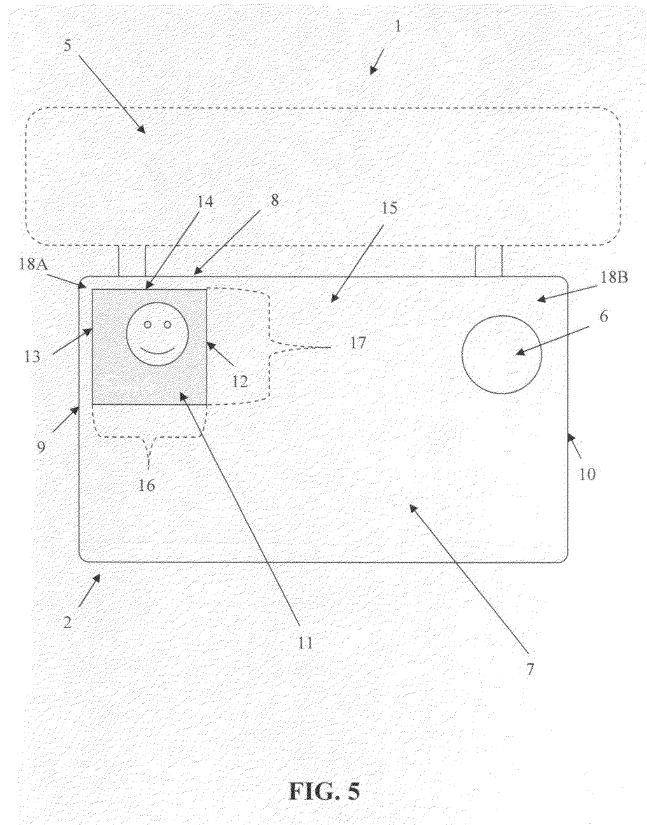

figure five (labeled “FIG. 5” in the drawings) illustrates one preferred position of the advertisement.

### DETAILED DESCRIPTION

The present specification explains preferred implementations of a method of displaying an advertisement or graphic on a seat or meal tray of a vehicle. The present detailed description does not limit the scope of the method of displaying an advertisement and the method may vary in its implementations. Furthermore, figures one through five illustrate preferred positions of the advertisement and the figures are merely devices for assisting the explanation of the present detailed description and do not limit the scope of the method.

The method includes a step of displaying an advertisement on a seat or meal tray of a vehicle: either by printing the advertisement directly on the seat or meal tray; by sticking a label, having the advertisement, onto the seat or meal tray; or by connecting to the seat or meal tray any known device that displays an advertisement.

In preferred implementations of the method, the advertisement is on a label that adheres, by way of an adhesive, to a seat or meal tray of a vehicle. The adhesive is a polyester-based adhesive and the adhesive includes a flame retardant in its makeup.

In preferred implementations of the method, the label is a laminated label.

In preferred implementations of the method, the width and height of the label is within a range of four to seven inches. In preferred implementations of the method, the laminated label is either six inches by six inches, or five and a half inches by five and a half inches.

In preferred implementations of the method, the advertisement has a color scheme of one, two, three, or four colors.

In preferred implementations of the method, the label is rectangular, and the corners of the label are rounded.

In preferred implementations of the method, a device displays the advertisement, which is made up of: a substrate having a top surface and a bottom surface; the advertisement, which is facing out from the top surface of the substrate; an adhesive that covers the entire area of the bottom surface of the substrate, where the adhesive is made of a fire-retardant polyester; and a laminate that covers the entire area of the top surface of the substrate, sandwiching the advertisement between the laminate and the substrate. Where the device displays the advertisement, the color scheme of the advertisement is either a one-color scheme, a two-color scheme, a three-color scheme, or a four-color scheme. In addition, the device has round corners.

Figures one through five illustrate a seat of a vehicle 1 comprising a meal tray 2 that has two basic states, open and closed (i.e. upright and fastened position). In figures two, three and five, the tray 2 is open. In figures one and four, the tray 2 is closed.

In figures one and three, the meal tray 2 displays an advertisement 3A & 3C. In figure one, the meal tray 2 displays an advertisement 3A on a bottom surface 22 of the meal tray 2. In figure three, the meal tray 2 displays an advertisement 3C on a top surface of the meal tray. If the meal tray 2 of figure three is in a closed state, then the advertisement 3C is not visible to a person sitting behind the seat 1.

In preferred embodiments of the method, where the advertisement has a width of four to seven inches, a height of four to seven inches, and the bottom surface 22 of the meal tray displays the advertisement, and an upper corner 21A or 21B of the bottom surface 22 of the meal displays the advertisement.

In preferred implementations of the method where the top surface of a meal tray displays an advertisement, the advertisement only partially covers the surface.

In the figures two and four, back parts of the seat 1 display advertisements 3B, 3D & 3E.

In figure four, back parts of the seat 1 display the advertisements 3D & 3E, where the advertisements are visible when the meal tray 2 is closed. More specifically, in figure four an outside surface of a pocket 4 on a lower part of the seat 1 displays one of the advertisements 3E.

In preferred embodiments of the method, where the advertisement has a width of four to seven inches, a height of four to seven inches, and the outside surface of the pocket 4 displays the advertisement, and an upper corner 20A or 20B of the outside surface of the pocket 4 displays the advertisement.

In figure two, a back part of the seat 1 displays an advertisement 3B, where the meal tray 2 covers the advertisement 3B when the meal tray 2 is closed.

In preferred embodiments of the method, where the advertisement has a width of four to seven inches, a height of four to seven inches, and the back part of the seat in figure two displays the advertisement, and an upper corner 19A or 19B of the back part displays the advertisement.

In figure five, a top surface 7 of a meal tray 2 attached to a seat of a vehicle 1 displays an advertisement 11.

Only a top surface 5 of the seat 1 is visible to a viewer of figure five.

As shown in figure five, a front part 15 of the top surface of the meal tray 7, which is at a corner on another side of the tray from a drink holder 6, displays the advertisement 11. If there is not a drink holder on the top surface of the meal tray 7, either corner 18A & 18B of the front part 15 displays the advertisement 11. As previously mentioned, in preferred implementations of the method, the advertisement 11 has a width 16 of four to seven inches and a height 17 of four to seven inches.

In preferred implementations of the method similar to the implementation illustrated in figure five, an upper edge of the advertisement 14 is within an inch and a half of an upper edge of the meal tray 8. If the advertisement is on the left side of the tray then a left edge of the advertisement 13 is within an inch and a half of a left edge of a meal tray 9. If the advertisement is on the right side of the tray then a right edge of the advertisement 12 is within an inch and a half of a right edge of the meal tray 10.

In other implementations of the method, a front or a side part of a seat of a vehicle displays an advertisement.

In other implementations of the method, a seat has multiple meal trays or does not have a meal tray. Furthermore, the method may include displaying multiple advertisements at multiple positions of a seat or a meal tray.

In preferred implementations of the method, an advertisement is printed on a laminated sticker, where the laminate material and adhesive of the sticker is heat and water-resistant. The laminate also is graffiti resistant. Moreover, the sticker adheres to the surface of a meal tray for at least sixty days.

1. A method of advertising by displaying an advertisement on a top surface of a meal tray of a seat of a vehicle, where a front part of the top surface, which is at an opposite corner of a drink holder, displays the advertisement; and if there is not a drink holder on the top surface of the meal tray, then either corner of the front part of the top surface displays the advertisement.

2. The method of claim 1, where the advertisement has a width of four to seven inches and a height of four to seven inches.

3. The method of claim 1, wherein: an upper edge of the advertisement is within an inch and a half of an upper edge of the meal tray; if the advertisement is on the left side of the tray, then a left edge of the advertisement is within an inch and a half of a left edge of the meal tray; and if the advertisement is on the right side of the tray, then a right edge of the advertisement is within an inch and a half of a right edge of the meal tray.

4. The method of claim 1, where the advertisement is a print on the top surface of the meal tray.

5. The method of claim 1, where a device displays the advertisement and the device comprises in combination: a substrate having a top surface and a bottom surface;
the advertisement, which is facing out from the top surface of the substrate; an adhesive that covers the entire area of the bottom surface of the substrate, where the adhesive is made of a fire-retardant polyester; and a laminate that covers the entire area of the top surface of the substrate, sandwiching the advertisement between the laminate and the substrate.

6. The method of claim 5, where the device has round corners.

7. The method of claim 1, where the color scheme of the advertisement is selected from a group consisting a one-color scheme, a two-color scheme, a three-color scheme, and a four-color scheme.

8. A method of advertising by displaying an advertisement on a part of a back surface of a seat of a vehicle, where a meal tray of the seat covers the advertisement if there is a meal tray connected to the seat and the meal tray is in an upright and fastened position.

9. The method of claim 8, where the advertisement has a width of four to seven inches and a height of four to seven inches, and an upper corner of the back surface displays the advertisement.

10. The method of claim 8, where the advertisement is a print on the back surface.

11. The method of claim 8, where a device displays the advertisement and the device comprises in combination: a substrate having a top surface and a bottom surface;
the advertisement, which is facing out from the top surface of the substrate; an adhesive that covers the entire area of the bottom surface of the substrate, where the adhesive is made of a fire-retardant polyester; and a laminate that covers the entire area of the top surface of the substrate, sandwiching the advertisement between the laminate and the substrate.

12. The method of claim 8, where the color scheme of the advertisement is selected from a group consisting a one-color scheme, a two-color scheme, a three-color scheme, and a four-color scheme.

13. A method of advertising by displaying an advertisement on an outside surface of a pocket that is on a bottom part of a back part of a seat of a vehicle.

14. The method of claim 13, where the advertisement has a width of four to seven inches and a height of four to seven inches, and an upper corner of the outside surface of the pocket displays the advertisement.

15. The method of claim 13, where the advertisement is a print on the outside surface of the pocket.

16. The method of claim 13, where a device displays the advertisement and the device comprises in combination: a substrate having a top surface and a bottom surface;
the advertisement, which is facing out from the top surface of the substrate; an adhesive that covers the entire area of the bottom surface of the substrate, where the adhesive is made of a fire-retardant polyester; and a laminate that covers the entire area of the top surface of the substrate, sandwiching the advertisement between the laminate and the substrate.

17. A method of advertising by displaying an advertisement on a bottom surface of a meal tray of a seat of a vehicle.

18. The method of claim 17, where the advertisement has a width of four to seven inches and a height of four to seven inches, and an upper corner of the bottom surface of the meal tray displays the advertisement.

19. The method of claim 17, where the advertisement is a print on the bottom surface of the meal tray.

20. The method of claim 17, where a device displays the advertisement and the device comprises in combination: a substrate having a top surface and a bottom surface; the advertisement, which is facing out from the top surface of the substrate; an adhesive that covers the entire area of the bottom surface of the substrate, where the adhesive is made of a fire-retardant polyester; and a laminate that covers the entire area of the top surface of the substrate, sandwiching the advertisement between the laminate and the substrate.
